(19) United States
(12) Patent Application Publication
(10) Pub. No.: US 2019/0356992 A1
(43) Pub. Date: Nov. 21, 2019

(54) Binaural Hearing System

(71) Applicant: Sonova AG, Staefa (CH)

(72) Inventor: Matthias Riepenhoff, Zürich (CH)

(21) Appl. No.: 16/476,298

(22) PCT Filed: Jan. 6, 2017
(86) PCT No.: PCT/EP2017/050271

§ 371 Date: Jul. 7, 2019

(51) Int. Cl. H04R 25/00

(52) U.S. Cl. CPC H04R 25/552; H04R 25/554; H04R 2460/03; H04R 25/602; H04R 25/604; H04R 25/556

(57) ABSTRACT

A binaural hearing system (1) comprising two hearing devices (2, 2′) for arrangement in a user's left and right ear, respectively, each of said devices (2, 2′) comprising a processor (3, 3′), a secondary battery (4, 4′), a microphone (5, 5′), a receiver (6, 6′), a wireless interface (7, 7′) for enabling at least a wireless connection (13) between the two hearing devices (2, 2′), a socket (9, 9′), a link cable (10) for interconnecting the two hearing devices (2, 2′) by connecting the link cable (10) to each of said sockets (9, 9′), wherein the processor (3, 3′) is configured such that the wireless connection (13) is disabled, when the two hearing devices (2, 2′) are interconnected by the link cable (10), the link cable thereby enabling a wired connection between the two hearing devices (2, 2′).

### TECHNICAL FIELD OF THE INVENTION

The current invention relates to binaural hearing systems according to the pre-characterizing part of claim 1, to a hearing device according to the pre-characterizing part of claim 8, as well as to a link cable for the binaural hearing system.

### DESCRIPTION OF THE RELATED ART

Binaural hearing systems are known for example from WO 99/43185A. A binaural hearing system comprises two hearing devices, which exchange information through a link. Hearing devices have been introduced which comprise a rechargeable battery also referred to as secondary battery or accu. A hearing device is worn at the ear of a user. Space and weight restrictions limit the energy storage capacity of the battery. The current consumption of the binaural link is critical for the usage time of the system.

### SUMMARY OF THE INVENTION

It is an object of the current invention to provide an improved binaural hearing system.

The problem is solved by a binaural hearing system with the features of claim 1. Further embodiments of the binaural hearing system, a hearing device as well as a link cable are defined by the features of further claims.

A binaural hearing system according to the current invention comprises:
two hearing devices for arrangement in a user's left and right ear, respectively, each of said devices comprising:
   a processor,
   a secondary battery, operationally connected at least to the processor,
   at least one microphone, operationally connected at least to the processor,
   a receiver, operationally connected at least to the processor,
   a wireless interface for enabling at least a wireless connection between the two hearing devices, operationally connected at least to the processor,
   a socket, operationally connected at least to the processor,
a link cable for interconnecting the two hearing devices by connecting the link cable to each of said sockets,
   wherein the processor is configured such that the wireless connection is disabled, when the two hearing devices are interconnected by the link cable, the link cable thereby enabling a wired connection between the two hearing devices.

The interconnection of the two hearing devices with a link cable allows the reduction of the energy consumption, as the wired connection requires less electrical energy as the wireless connection.

At the same time, the link cable prevents either of the two hearing devices from falling to the ground, when unintentionally falling out of the user's ear.

Disabling the wireless connection between the two hearing devices allows it to use the wireless interface for another wireless connection to another device, i.e. a mobile device, such as a mobile phone, a laptop or the like, or a stationary device, such as an internal telephone, a television, a radio or another media device.

Alternatively the wireless interface can be switched off and thereby disabling any wireless connection to and from the hearing devices by means of the wireless interface. With this the binaural hearing system can be switched from a normal mode to a flight mode.

The link cable of a further embodiment comprises an auxiliary transmitter, for example a T-coil or a Bluetooth interface, which is operationally connected to one or both hearing devices by means of the link cable. Operationally connected in this patent application means that the two connecting elements can be directly or indirectly be connected to one another. This auxiliary transmitter can be used to connect the hearing devices to mobile or stationary devices as described above.

In another embodiment, the link cable comprises an integrated power supply unit, for example a battery, which is operationally connected to both hearing devices by means of the link cable. With this, the secondary batteries, such as lithium polymer batteries, lithium-ion batteries, nickel-metal hybrid batteries, nickel-cadmium batteries, lead batteries or lead gel batteries of the hearing devices can be charged or the integrated power supply can work in a power sharing mode with the energy storages of the hearing devices, wherein the energy consumption is evenly distributed between these members or the total available energy of these members is evenly distributed between these members. In the power sharing mode a hearing device may share the energy with the other hearing device of the binaural hearing system. For example a current used by a hearing device may be drawn from the battery of the other hearing device. This enables the extension of the duration of use of the single hearing devices and therefor of the binaural hearing system.

The link cable of another embodiment comprises a power connector, which is operationally connected to both hearing devices by means of the link cable, wherein the power connector is adapted to be connected to a detachable power supply unit. This power connector allows to recharge the power storages of the hearing devices or the operation of a power sharing mode, as described above. The detachable power supply unit can be a rechargeable or non-rechargeable battery or a recharger with a power connection.

In another embodiment, the link cable comprises a link connector at each of its free ends, wherein each link connector comprises manually releasable fixation elements for securing the link connectors to the respective hearing device. Such fixation elements can be interlocking elements or frictional locking elements or magnetic elements. With these elements there is no need for the use of a tool to connect or disconnect the link cable to the hearing devices.

The two hearing devices of another embodiment each further comprise a controller, operationally connected to at least the processor, wherein the controller is configured to detect when the link cable is interconnecting the two hearing devices. The controller can be a separate entity or can be an integrated part of the processor.

In a further embodiment, the controller is configured to enable a power sharing between the secondary batteries of the two hearing devices, when they are interconnected by the link cable. The controller can be integrated in the processor. The controller can be controlled by the processor partially or fully.

The above-mentioned embodiments of the binaural hearing system can be used in any combination, unless they contradict each other.

A hearing device for use in a binaural hearing system according to the current invention comprises:
a processor,
an secondary battery, operationally connected at least to the processor,
at least one microphone, operationally connected at least to the processor,
a receiver, operationally connected at least to the processor,
a wireless interface for enabling at least a wireless connection between the hearing devices and a corresponding second hearing device, operationally connected at least to the processor,
a socket, operationally connected at least to the processor,
   wherein the processor is configured as such that the wireless connection is disabled, when the hearing device is interconnected with another corresponding hearing device by a link cable, the link cable thereby enabling a wired connection between the two hearing devices.

As the hearing device is for use in a binaural hearing system according to the invention, the same features have the same effects and advantages as stated above.

The hearing device of another embodiment further comprises a controller, operationally connected at least to the processor, the controller being configured to detect when the link cable is interconnecting the two hearing devices.

In a further embodiment, the controller is configured to enable a power sharing between the secondary batteries of the two hearing devices, when they are interconnected by the link cable.

The above-mentioned embodiments of the binaural hearing devices can be used in any combination, unless they contradict each other.

A link cable for use in a binaural hearing system according to the current invention is adapted to trigger a disablement of a wireless connection between two hearing devices, when interconnecting the two hearing devices, while at the same time enabling a wired connection between the two hearing devices. The triggering can be active, for example when the link cable is mechanically connected to the hearing device, for example when the cable is plugged in the socket or the triggering can be passive, for example when the controller or the processor of one hearing device detects the controller or processor of the other hearing device through the link cable.

As the link cable is for use in a binaural hearing system according to the invention, the same features have the same effects and advantages as stated above.

The link cable of another embodiment comprises an auxiliary transmitter, for example a T-coil or a Bluetooth interface.

The link cable of a further embodiment comprises an integrated power supply unit.

In another embodiment, the link cable comprises a power connector, wherein the power connector is adapted to be connected to a detachable power supply unit.

In a further embodiment, the link cable comprises a link connector at each of its free ends, wherein each link connector comprises manually releasable fixation elements for securing the link connectors to the respective hearing device.

The above-mentioned embodiments of the link cable can be used in any combination, unless they contradict each other.

### BRIEF DESCRIPTION OF THE DRAWINGS

Embodiments of the current invention are described in more detail in the following with reference to the figures. These are for illustrative purposes only and are not to be construed as limiting. It shows

FIG. 1 a schematic representation of a binaural hearing system according to the current invention with two hearing devices and a link cable;

FIG. 2 a schematic representation of a binaural hearing system according to the current invention with two hearing devices and a link cable with an auxiliary transmitter;

FIG. 3 a schematic representation of a binaural hearing system according to the current invention with two hearing devices and a link cable with an integrated power supply unit; and

FIG. 4 a schematic representation of a binaural hearing system according to the current invention with two hearing devices and a link cable with a detachable power supply unit.

### DETAILED DESCRIPTION OF THE INVENTION

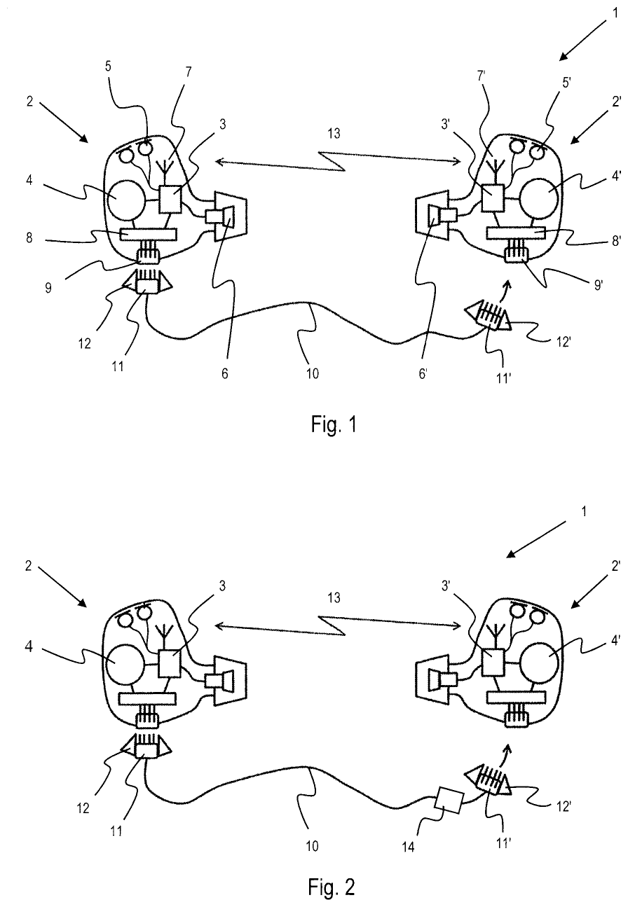

FIG. 1 shows a schematic representation of a binaural hearing system 1 according to the current invention with two hearing devices 2, 2′ and a link cable 10. Each hearing device 2, 2′ comprises a processor 3, 3′, a secondary battery 4, 4′, at least one microphone 5, 5′, a receiver 6, 6′, a wireless interface 7, 7′, a controller 8, 8′ and a socket 9, 9′. The processor 3, 3′ is operationally connected to the secondary battery 4, 4′, the at least one microphone 5, 5′, the receiver 6, 6′, the wireless interface 7, 7′ and the controller 8, 8′. The secondary battery 4, 4′ is connected to the controller 8, 8′. The wireless interfaces 7, 7′ enable a wireless connection 13 between the two hearing devices 2, 2′.

The link cable 10 comprises a link connector 11, 11′ at each of its free ends, wherein each link connector 11, 11′ comprises manually releasable fixation elements 12, 12′ for securing the link connectors 11, 11′ to the respective hearing device 2, 2′. Each of the two link connector 11, 11′ can be plugged in a socket 9, 9′ of a respective hearing device 2, 2′.

FIG. 2 shows a schematic representation of a binaural hearing system 1 according to the current invention with two hearing devices 2, 2′ and a link cable 10 with an auxiliary transmitter 14. The auxiliary transmitter 14 can be connected to the hearing devices 2, 2′ by means of the link cable 10. Apart from the auxiliary transmitter 14, the depicted elements are identical to those of FIG. 1, wherein identical elements have an identical reference number.

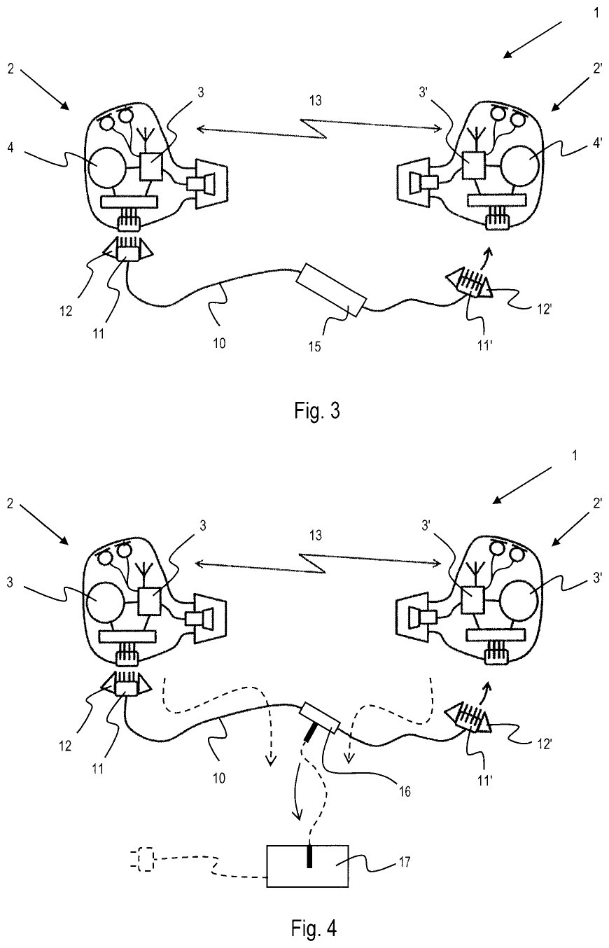

FIG. 3 shows a schematic representation of a binaural hearing system 1 according to the current invention with two hearing devices 2, 2′ and a link cable 10 with an integrated power supply unit 15. The integrated power supply unit 15 can be connected to the hearing devices 2, 2′ by means of the link cable 10. The integrated power supply unit 15 is the only difference between the embodiments of FIGS. 1 and 3, wherein identical elements have an identical reference number.

FIG. 4 shows a schematic representation of a binaural hearing system 1 according to the current invention with two hearing devices 2, 2′ and a link cable 10 with a detachable power supply unit 17. The link cable 10 comprises a power connecter 16 for the connection to the detachable power supply unit 17. The power connecter 16 can be connected to the hearing devices 2, 2′ by means of the link cable 10, thereby enabling a connection to the hearing devices 2, 2′ for the detachable power supply unit 17. The detachable power supply unit 17 is a battery that can be carried around or is a loading/charging unit that is stationary and has a power cable, as indicated with the dashed lines.

### REFERENCE SIGNS LIST

1 Binaural hearing system
2, 2′ Hearing device
3, 3′ Processor
4, 4′ Battery
5, 5′ Microphone
6, 6′ Receiver
7, 7′ Wireless interface
8, 8′ Controller
9, 9′ Socket
10 Link cable
11, 11′ Link connector
12, 12′ Detent
13 Wireless connection
14 T-coil
15 integrated power supply unit
16 Power connector
17 detachable power supply unit

1-15. (canceled)

16. A binaural hearing system comprising:
a hearing device configured for a left ear;
a hearing device configured for a right ear;
each of hearing device comprising:
a processor,
a battery electronically coupled the processor,
a microphone electronically coupled to the processor,
a receiver electronically coupled to the processor,
a wireless interface for enabling a wireless connection between the left and right hearing devices,
a socket electronically coupled to the processor,
a link cable configured to electronically interconnect the hearing devices via the sockets,
wherein the processor is configured to disable the wireless connection when the two hearing devices are interconnected by the link cable.

17. The binaural hearing system of claim 16, wherein the link cable comprises an auxiliary transmitter.

18. The binaural hearing system of claim 16, wherein the link cable comprises an integrated power supply unit that is electronically coupled to both hearing devices by means of the link cable.

19. The binaural hearing system of claim 18, wherein the link cable comprises a power connector that operationally connected to both hearing devices by means of the link cable, wherein the power connector is adapted to be connected to a detachable power supply unit.

20. The binaural hearing system of claim 19, wherein the link cable comprises a link connector at each of its free ends, wherein each link connector comprises manually releasable fixation elements for securing the link connectors to the respective hearing device.

21. The binaural hearing system of claim 20, wherein each of the two hearing devices further comprises a controller configured to detect when the link cable is interconnecting the two hearing devices.

22. The binaural hearing system of claim 21, wherein the controller is configured to enable a power sharing between the secondary batteries of the two hearing devices.

23. A hearing device comprising:
a processor,
a secondary battery,
a microphone coupled to the processor,
a receiver coupled to the processor,
a wireless interface for enabling a wireless connection to another hearing device,
a socket electronically coupled to the processor,
wherein the processor is configured to disable the wireless connection when the two hearing devices are interconnected by the link cable.

24. The hearing device of claim 23, wherein the hearing device further comprises a controller configured to detect when the link cable is interconnecting the two hearing devices.

25. The hearing device of claim 23, wherein the controller is configured to enable a power sharing between the secondary batteries of the two hearing devices when they are interconnected by the link cable.
